(19) United States
(12) Patent Application Publication
(10) Pub. No.: US 2026/0009347 A1
(43) Pub. Date: Jan. 8, 2026

(54) BREATHER SYSTEM FOR A CRANKCASE

(71) Applicant: HENGST SE, Muenster (DE)

(72) Inventors: Eike STITTERICH, Senden (DE); Martin ROELVER, Havixbeck (DE); Burkhard VORWICK, Werne (DE); Sergej KONKOV, Muenster (DE)

(21) Appl. No.: 19/107,418

(22) PCT Filed: Aug. 17, 2023
(86) PCT No.: PCT/EP2023/072688

§ 371 Date: Feb. 27, 2025

(30) Foreign Application Priority Data
Aug. 31, 2022 (DE) 10 2022 121 952.6

(51) Int. Cl. F01M 13/00; F01M 13/04; F02B 43/10

(52) U.S. Cl. CPC F01M 13/0011; F01M 13/04; F02B 43/10; F01M 2013/0422; F01M 2250/60

(57) ABSTRACT

The invention relates to a breather system (10) for a crankcase (102) of an internal combustion engine (100) operable with a gaseous fuel, in particular for a crankcase (102) of a hydrogen internal combustion engine, in which leakage gas containing the fuel and/or reaction products of the fuel enters the crankcase (102) during the combustion process, with a leakage gas discharge line (14) for discharging from the crankcase (102) a gas mixture (G) comprising a ventilation gas and leakage gas introduced into the crankcase (102) and one or more flow adjustment devices (16a, 16b) for adjusting the volume flow of the ventilation gas introduced into the crankcase (102) and/or the volume flow of the gas mixture (G) discharged from the crankcase (102), wherein one flow adjustment device (16a) is designed as a centrifugal separator, in particular as a disk separator, for conveying the discharged gas mixture (G) through the leakage gas discharge line (14).

The invention relates to a breather system for a crankcase of an internal combustion engine operable with a gaseous fuel, in which leakage gas containing the fuel and/or reaction products of the fuel enters the crankcase during the combustion process. The breather system comprises a leakage gas discharge line for discharging from the crankcase a gas mixture comprising a ventilation gas and leakage gas introduced into the crankcase and one or more flow adjustment devices for adjusting the volume flow of the ventilation gas introduced into the crankcase and/or the volume flow of the gas mixture discharged from the crankcase, wherein one flow adjustment device is designed as a centrifugal separator, in particular as a disk separator, for conveying the discharged gas mixture through the leakage gas discharge line.

The invention also relates to an internal combustion engine, which can be operated with a gaseous fuel, wherein the internal combustion engine comprises a crankcase and a breather system for the crankcase.

In addition, the invention relates to a method for venting a crankcase of an internal combustion engine operable with a gaseous fuel, in which leakage gas containing the fuel and/or reaction products of the fuel enters the crankcase during the combustion process, by means of a breather system, comprising the steps: Discharging a gas mixture comprising a ventilation gas and leakage gas introduced into the crankcase from the crankcase via a leakage gas discharge line of the breather system and adjusting the volume flow of the ventilation gas introduced into the crankcase and/or the volume flow of the gas mixture discharged from the crankcase by means of one or more flow adjustment devices of the breather system, wherein a flow adjustment device is designed as a centrifugal separator, in particular as a disk separator, for conveying the discharged gas mixture through the leakage gas discharge line.

For crankcase ventilation, it is necessary to introduce a ventilation gas into the crankcase so that a gas mixture comprising the ventilation gas and the leakage gas can be discharged from the crankcase. Disc separators, for example, are used in the state of the art to generate the flow.

A ventilation system for a crankcase is known from the publication U.S. Pat. No. 7,152,589 B2, in which the speed of a disk separator is controlled as a function of the pressure in the crankcase. In this way, the pressure in the crankcase can be kept constant.

Internal combustion engines that can be operated with a gaseous fuel are also known from the prior art. For example, publication DE 10 2021 133 918 A1 discloses a ventilation system for a crankcase of such an internal combustion engine.

In internal combustion engines that can be operated with a gaseous fuel, neither the fuel nor the reaction products of the fuel may accumulate in the crankcase or in the leakage gas discharge line, as the gas mixture to be discharged is highly flammable and explosive if the quantity and/or concentration of the fuel and/or the reaction products is too high. To ensure that internal combustion engines that can be operated with a gaseous fuel can be operated safely, it must therefore be ensured that no highly flammable and explosive gas mixture flows through the crankcase and its ventilation system.

To ensure safe operation of an internal combustion engine, it may also be necessary to avoid excessive accumulation of water vapor in the crankcase. The water can mix with the engine oil, impairing the lubricating properties of the engine oil. Furthermore, the water can freeze, which can also result in damage to the combustion engine.

The task underlying the invention is therefore to increase the safety when operating an internal combustion engine with a crankcase ventilation system that can be operated with a gaseous fuel.

The problem is solved by a breather system of the type mentioned at the beginning, wherein the ventilation system according to the invention has a control device which is set up to control the one or more flow adjustment devices as a function of a quantity and/or concentration of the fuel and/or the reaction products in at least one area of the breather system in order to change the volume flow of the ventilation gas introduced into the crankcase and/or in order to change the volume flow of the gas mixture discharged from the crankcase.

Changing the volume flow of the ventilation gas introduced into the crankcase and/or changing the volume flow of the gas mixture discharged from the crankcase prevents fuel and/or reaction products of the fuel from accumulating inside the crankcase and/or the leakage gas discharge line, thereby preventing the formation of a highly flammable and explosive gas mixture and/or excessive dilution of the engine oil with water. By controlling the one or more flow adjustment devices, the flow speed and the volume flow in the crankcase and in the leakage gas discharge line can be increased so that the removal of the gas mixture comprising the leakage gas is accelerated. By controlling one or more flow adjustment devices, the ventilation of the crankcase can be increased as required. The breather system can therefore effectively remove highly flammable and explosive gas mixtures and/or moisture, for example. The breather system according to the invention thus ensures safe operation of an internal combustion engine that can be operated with a gaseous fuel.

The fuel can be hydrogen, methane (CH₄) or ammonia (NH₃), for example. The reaction products can be nitrogen oxides (NOₓ), carbon monoxide (CO) or water vapor.

A flow adjustment device is designed as a centrifugal separator, in particular as a disk separator, for conveying the discharged gas mixture through the leakage gas discharge line. The control device is preferably set up to control the conveying performance of the centrifugal separator as a function of the quantity and/or concentration of the fuel and/or the reaction products in the at least one area of the breather system. The flow speed and/or the volume flow in the leakage gas discharge line can be increased by adjusting the conveying performance so that the removal of the gas mixture comprising the leakage gas is accelerated. The ventilation of the crankcase can be increased by adjusting the conveying performance. The centrifugal separator can be driven, in particular hydraulically, pneumatically and/or electrically.

Alternatively, the flow adjustment device designed as a centrifugal separator can also be a different conveying direction for conveying the discharged gas mixture through the leakage gas discharge line.

The centrifugal separator can comprise a conveyor rotor, which is equipped with several separator elements. The separator elements can be separator disks, which are stacked to form a disk pack. The centrifugal separator or disk separator therefore also performs a separation function in addition to the conveying function. The centrifugal separator, which can be designed as a disk separator, is preferably set up to separate liquid particles, for example oil particles, from the gas mixture discharged from the crankcase.

In a preferred further development of the breather system according to the invention, the centrifugal separator has a conveyor drive which is set up to rotationally drive a conveying rotor of the centrifugal separator. The control device is preferably set up to control the conveying performance of the centrifugal separator via the setting of a rotational speed on the conveyor drive. The speed on the conveyor drive can be set, for example, by controlling the drive power.

In a further preferred embodiment of the breather system according to the invention, a flow adjustment device is designed as a ventilation valve for adjusting the volume flow of the ventilation gas introduced into the crankcase. The control device is preferably set up to adjust the ventilation valve as a function of a quantity and/or concentration of the fuel and/or the reaction products in the at least one area of the breather system. The adjustment of the breather system can, for example, involve changing the flow cross-section of the ventilation valve. The ventilation gas can be exhaust gas. In this case, the crankcase is ventilated with exhaust gas from an exhaust line coming from combustion chambers of the internal combustion engine. The ventilation gas can also be fresh air. In this case, the crankcase is ventilated with fresh air from an suction line leading to combustion chambers of the internal combustion engine.

Furthermore, a breather system according to the invention is preferred which comprises a ventilation line for introducing the ventilation gas into the crankcase, wherein the ventilation valve is preferably arranged on the ventilation line. The ventilation line is preferably a high-pressure line, which is located downstream of a compressor of an exhaust gas turbocharger of the internal combustion engine in the direction of flow, or a low-pressure line, which is located upstream of a compressor of an exhaust gas turbocharger of the internal combustion engine in the direction of flow. A suitable pressure reduction can then be carried out via the ventilation valve so that the intended amount of ventilation gas is introduced into the crankcase.

In a further preferred embodiment, the breather system according to the invention has at least one measuring device which is set up to measure the quantity and/or concentration of the fuel and/or the reaction products in the at least one area, wherein the control device is set up to control the one or more flow adjustment devices as a function of the quantity and/or concentration of the fuel and/or the reaction products measured by the measuring device in the at least one area of the breather system for varying the volume flow of the ventilation gas introduced into the crankcase and/or for varying the volume flow of the gas mixture discharged from the crankcase. For example, the control device is set up to control the conveying performance of the centrifugal separator as a function of the quantity and/or concentration of the fuel and/or the reaction products measured by the measuring device in the at least one area of the breather system. For example, the control device is set up to adjust the ventilation valve as a function of the quantity and/or concentration of the fuel and/or the reaction products measured by the measuring device in the at least one area of the breather system. The at least one measuring device can be set up to measure the quantity and/or concentration of hydrogen, methane, ammonia, nitrogen oxides and/or carbon monoxide or the moisture, in particular the relative humidity, in the at least one area. The at least one measuring device can be a hydrogen sensor, a methane sensor, an ammonia sensor, a nitrogen oxide sensor, a carbon monoxide sensor or a humidity sensor.

In a further preferred embodiment, the breather system according to the invention has a data processing device which is set up to calculate the quantity and/or concentration of the fuel and/or the reaction products for the at least one area, wherein the control device is set up to control the one or more flow adjustment devices as a function of the quantity and/or concentration of the fuel and/or the reaction products calculated by the data processing device for the at least one area of the breather system in order to change the volume flow of the ventilation gas introduced into the crankcase and/or in order to change the volume flow of the gas mixture discharged from the crankcase. The data processing device preferably uses a calculation data set to calculate the quantity and/or concentration of the fuel and/or the reaction products. The calculation data set may, for example, comprise operating parameters of the breather system and/or the internal combustion engine. The calculation data set can also comprise breather system-specific system parameters and/or internal combustion engine-specific engine parameters.

In a further preferred embodiment of the ventilation system according to the invention, at least one measuring device is arranged in the crankcase. Alternatively or additionally, at least one measuring device is arranged in a flow adjustment device. Alternatively or additionally, at least one measuring device is arranged on the leakage gas discharge line. Alternatively or additionally, at least one measuring device is arranged on a suction line leading to combustion chambers of the internal combustion engine. Alternatively or additionally, at least one measuring device is arranged on an exhaust gas line coming from combustion chambers of the internal combustion engine. At least one measuring device can be arranged in the centrifugal separator. At least one measuring device can be arranged upstream or downstream of the centrifugal separator in the direction of flow of the gas mixture comprising the leakage gas. The at least one measuring device can be arranged in or on the ventilation valve.

At least one area, in which the quantity and/or concentration of the fuel and/or the reaction products is measured and/or for which the quantity and/or concentration of the fuel and/or the reaction products is calculated, is preferably located in the crankcase, in a flow adjustment device, in the leakage gas discharge line, in a suction line leading to combustion chambers of the internal combustion engine or in an exhaust line coming from combustion chambers of the internal combustion engine. At least one area in which the quantity and/or concentration of the fuel and/or the reaction products is measured and/or for which the quantity and/or concentration of the fuel and/or the reaction products is calculated can be located in the centrifugal separator. At least one area in which the quantity and/or concentration of the fuel and/or the reaction products is measured and/or for which the quantity and/or concentration of the fuel and/or the reaction products is calculated may be located upstream or downstream of the centrifugal separator in the direction of flow of the gas mixture comprising the leakage gas. At least one area in which the quantity and/or concentration of the fuel and/or the reaction products is measured and/or for which the quantity and/or concentration of the fuel and/or the reaction products is calculated can be located in or at the ventilation valve.

In another preferred embodiment of the breather system according to the invention, the control device is set up to control the one or more flow adjustment devices as a function of the quantity and/or concentration of the fuel and/or reaction products in the at least one area of the breather system, if the quantity and/or concentration of the fuel and/or reaction products in the at least one area of the breather system exceeds a limit value. Alternatively or additionally, the control device is set up to control the one or more flow adjustment devices independently of the quantity and/or concentration of the fuel and/or the reaction products in the at least one area of the breather system, if the quantity and/or concentration of the fuel and/or the reaction products in the at least one area of the breather system falls below a limit value. In the case of hydrogen, for example, the limit value can be in a range between 5% and 30%, in particular around 10%. In the case of ammonia, for example, the limit value can be in a range between 1% and 10%, in particular around 4%.

A breather system according to the invention is also preferred, in which the control device is set up to control the one or more flow adjustment devices as a function of the pressure in the crankcase and/or a required media separation. Thus, when controlling the one or more flow adjustment devices, the pressure in the crankcase and/or the required media separation is also taken into account in addition to the quantity and/or concentration of the fuel and/or the reaction products in the at least one area of the breather system. The required media separation can relate to the required oil mist separation.

The problem underlying the invention is further solved by an internal combustion engine of the type mentioned at the beginning, wherein the breather system of the internal combustion engine according to the invention is designed according to one of the embodiments described above. With regard to the advantages and modifications of the internal combustion engine according to the invention, reference is made to the advantages and modifications of the breather system according to the invention. During operation of the internal combustion engine, the shutdown of the internal combustion engine can be avoided due to the breather system, since a critical quantity and/or concentration of the fuel and/or the reaction products is not exceeded due to the on-demand venting. In particular, if the internal combustion engine is an industrial engine, a cost-intensive interruption of a work process can thus be avoided.

The task on which the invention is based is furthermore solved by a method of the type mentioned at the beginning, wherein, as part of the method according to the invention, a control device of the breather system controls the one or more flow adjustment devices as a function of a quantity and/or concentration of the fuel and/or the reaction products in at least one area of the breather system for changing the volume flow of the venting gas introduced into the crankcase and/or for changing the volume flow of the gas mixture discharged from the crankcase. The method according to the invention is preferably carried out with a breather system according to one of the embodiments described above. With regard to the advantages and modifications of the method according to the invention, reference is thus first made to the advantages and modifications of the breather system according to the invention.

A flow adjustment device is designed as a centrifugal separator, in particular as a disk separator, for conveying the discharged gas mixture through the leakage gas discharge line, wherein the control device preferably controls the conveying performance of the centrifugal separator as a function of a quantity and/or concentration of the fuel and/or the reaction products in at least one area of the breather system. The control device preferably initiates an increase in the conveying performance of the centrifugal separator when the quantity and/or concentration of the fuel and/or the reaction products increases. Alternatively or additionally, the control device causes a reduction of the conveying performance of the centrifugal separator when the quantity and/or concentration of the fuel and/or the reaction products decreases. Preferably, a flow adjustment device is designed as a ventilation valve for adjusting the volume flow of the ventilation gas introduced into the crankcase, wherein the control device preferably adjusts the ventilation valve as a function of a quantity and/or concentration of the fuel and/or the reaction products in at least one area of the breather system. Preferably, the control device causes the free flow cross-section of the ventilation valve to be increased when the quantity and/or concentration of the fuel and/or the reaction products increases. Alternatively or additionally, the control device causes the free flow cross-section of the ventilation valve to be reduced when the quantity and/or concentration of the fuel and/or the reaction products decreases.

Alternatively, the flow adjustment device designed as a centrifugal separator can also be a different conveying direction for conveying the discharged gas mixture through the leakage gas discharge line.

In a further preferred embodiment of the method according to the invention, the quantity and/or concentration of the fuel and/or the reaction products in the at least one area is measured by means of at least one measuring device of the breather system. Alternatively or additionally, the quantity and/or concentration of the fuel and/or the reaction products for the at least one area is calculated by means of a data processing device of the breather system.

In the following, preferred embodiments of the invention are explained and described in more detail with reference to the accompanying drawings. Showing:

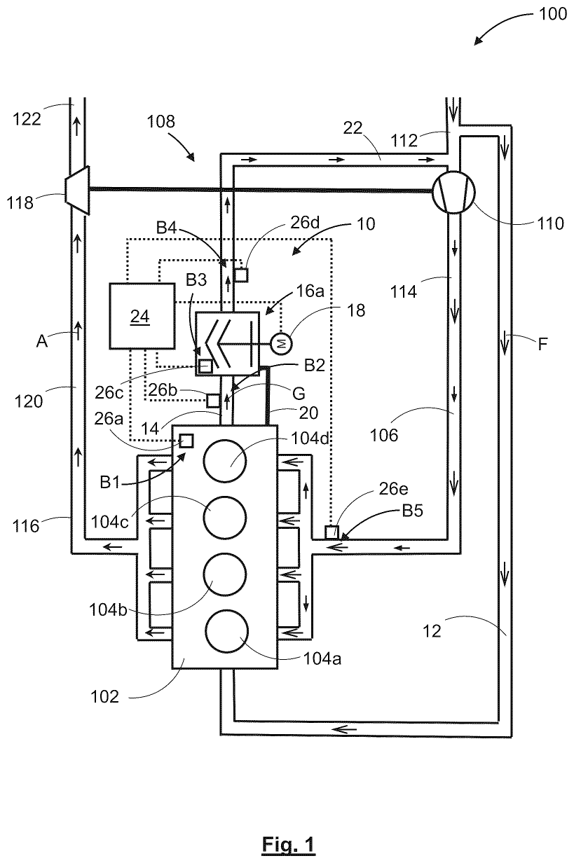

FIG. 1 a schematic representation of an internal combustion engine according to the invention;

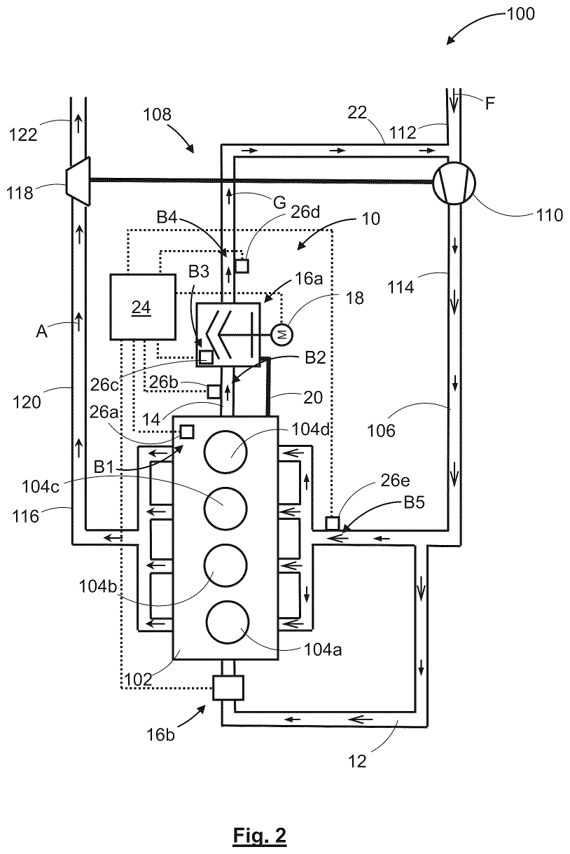

FIG. 2 a schematic representation of another internal combustion engine according to the invention; and

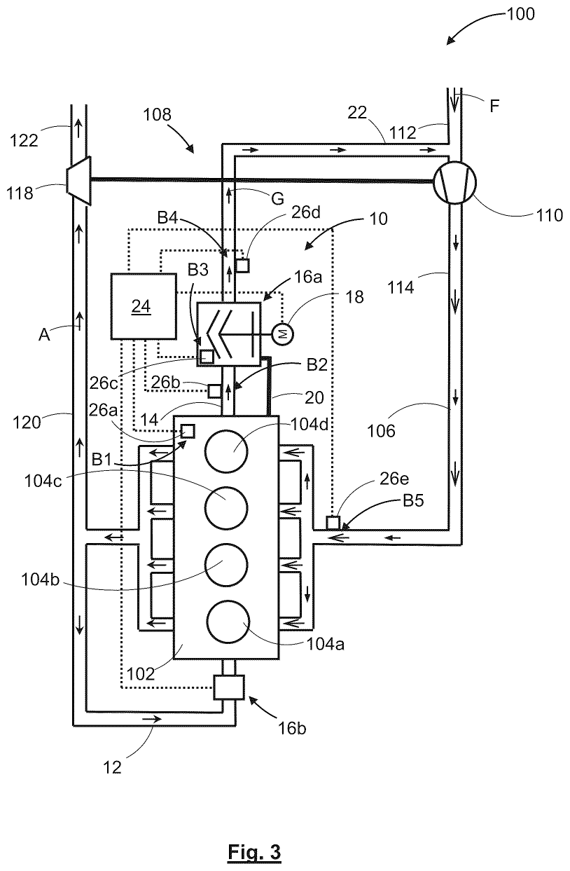

FIG. 3 a schematic representation of another internal combustion engine according to the invention.

FIG. 1 shows an internal combustion engine 100 which can be operated with a gaseous fuel, namely hydrogen. The internal combustion engine 100 comprises a crankcase 102 and a breather system 10 for the crankcase 102. An air-hydrogen mixture is combusted in the combustion chambers 104a-104d of the internal combustion engine 100. During the internal combustion engine, a leakage gas enters the crankcase 102, wherein the leakage gas contains the fuel, i.e. hydrogen, and reaction products of the fuel, for example nitrogen oxides (NOₓ), carbon monoxide (CO) or water vapor.

The internal combustion engine 100 comprises a suction line 106, which is divided into a low-pressure area 112 and a high-pressure area 114 by a compressor 110 of an exhaust gas turbocharger 108. The suction line 106 leads to the combustion chambers 104a-104d of the internal combustion engine 100, so that fresh air F for the combustion process is supplied to the combustion chambers 104a-104d via the suction line 106.

The exhaust gas A produced during the combustion process is discharged from the combustion chambers 104a-104d of the internal combustion engine 100 via an exhaust line 116. A turbine 118 of the exhaust gas turbocharger 108 divides the exhaust line 116 into a high-pressure area 120 and a low-pressure area 122.

The breather system 10 comprises a ventilation line 12 for introducing a ventilation gas into the crankcase 102. The ventilation line 12 is a low-pressure line, which is connected to the low-pressure area 112 of the suction line 106. The ventilation gas, which is used by the breather system 10 for crankcase ventilation, is therefore fresh air F in the present case. The crankcase 102 is ventilated with fresh air F from an suction line 106 leading to the combustion chambers 104a-104d of the internal combustion engine 100.

The breather system 10 further comprises a leakage gas discharge line 14 for discharging a gas mixture G from the crankcase 102. The gas mixture G comprises the ventilation gas introduced into the crankcase 102 and the leakage gas that has entered the crankcase 102 during the combustion process.

The leakage gas discharge line 14 leads to a flow adjustment device 16a. The flow adjustment device 16a is used to adjust the volume flow of the ventilation gas introduced into the crankcase 102 and the volume flow of the gas mixture G discharged from the crankcase 102. The flow adjustment device 16a is a conveying device for conveying the gas mixture G discharged through the leakage gas discharge line 14. Specifically, the flow adjustment device 16a is a centrifugal separator, namely a disk separator, which in addition to a conveying function also performs a separating function. The flow adjustment device 16a, which is designed as a disk separator, is used to separate oil particles from the gas mixture G, whereby the separated oil particles are fed back into the crankcase 102 of the internal combustion engine 100 via the oil return line 20.

The flow adjustment device 16a, which is designed as a disk separator, has a conveyor drive 18, via which the conveying performance of the flow adjustment device 16a can be adjusted. A gas return line 22 is connected to the flow adjustment device 16a, via which the gas mixture G is conveyed back into the low-pressure area 112 of the suction line 106.

The breather system 24 further comprises a control device 24 which controls the flow adjustment device 16a, which is designed as a disk separator, as a function of a quantity and/or concentration of the fuel, i.e. hydrogen, and/or the reaction products in at least one area B1-B5 of the breather system 10 for changing the volume flow of the ventilation gas introduced into the crankcase 102 and for changing the volume flow of the gas mixture G discharged from the crankcase 102. The control device 24 may take into account the quantity and/or concentration of fuel and/or reaction products in one or more areas B1-B5 when controlling the flow adjustment device 16a.

The control device 24 is set up to control the conveying performance of the flow adjustment device 16a, which is designed as a disk separator, as a function of the quantity and/or concentration of the fuel or the reaction products in one or more areas B1-B5. By adjusting the conveying performance, the flow velocity and the volume flow in the leakage gas discharge line 14 can be increased so that the removal of the gas mixture G containing the leakage gas is accelerated. By adjusting the conveying performance, the ventilation of the crankcase 102 can be increased. The control device 24 is set up to control the conveying capacity of the conveying device by setting a speed on the conveyor drive 18. The conveyor drive 18 is an electric motor.

The breather system 10 may comprise one or more measuring devices 26a-26e, wherein the one or more measuring devices 26a-26e measure the quantity and/or concentration of fuel and/or reaction products in a area B1-B5. The breather system 10 may comprise one or more of the illustrated measuring devices 26a-26e. Consequently, the control device 24 is arranged to control the flow adjustment device 16a as a function of the quantity and/or concentration of the fuel and/or the reaction products measured by one or more measuring devices 26a-26e in an area B1-B5 of the breather system for changing the volume flow of the ventilation gas introduced into the crankcase 102 and/or for changing the volume flow of the gas mixture G discharged from the crankcase 102. The measuring devices 26a-26e can be set up to measure the quantity and/or concentration of hydrogen, methane and/or ammonia in the area B1-B5 assigned to the respective measuring device 26a-26e. For example, a hydrogen sensor, a methane sensor, an ammonia sensor, a nitrogen oxide sensor, a carbon monoxide sensor or a humidity sensor can be used as the measuring device 26a-26e.

Alternatively or additionally to the one or more measuring devices 26a-26e, the breather system 10 can also have a data processing device which is set up to calculate the quantity and/or concentration of the fuel and/or the reaction products in one or more areas B1-B5. The control device then controls the flow adjustment device 16a, which is designed as a disk separator, as a function of the calculated quantity and/or concentration of the fuel and/or the reaction products.

The control device 24 triggers an increase of the conveying performance of the flow adjustment device 16a, which is designed as a disk separator, when the quantity and/or concentration of the fuel and/or the reaction products increases. Furthermore, the control device 24 causes a reduction in the conveying performance of the flow adjustment device 16a, which is designed as a disk separator, when the quantity and/or concentration of the fuel and/or the reaction products decreases.

FIG. 1 shows examples of possible positions of the measuring devices 26a-26e. The measuring device 26a is arranged in the crankcase 102. The measuring device 26b is arranged on the leakage gas discharge line 14. The measuring device 26c is arranged in the flow adjustment device 16a, which is designed as a disk separator. The measuring device 26d is arranged on the gas return line 22. The measuring device 26e is arranged on the suction line 106 leading to the combustion chambers 104a-104d of the internal combustion engine 100.

In the internal combustion engine 100 shown in FIG. 2, the ventilation line 12 of the breather system 10 is connected to the high-pressure area 114 of the suction line 106.

The breather system 10 further comprises a flow adjustment device 16b designed as a ventilation valve for adjusting the volume flow of the ventilation gas introduced into the crankcase 102. The flow adjustment device 16b designed as a ventilation valve is arranged on the ventilation line 12. The ventilation line 12 is a high-pressure line, which is located downstream of the compressor 110 of the exhaust gas turbocharger 108 in the direction of flow of the fresh air F.

The control device 24 is set up to adjust the flow adjustment device 16b, which is designed as a ventilation valve, depending on a quantity and/or concentration of the fuel and/or the reaction products in an area B1-B5 of the breather system 10. The adjustment of the ventilation valve can, for example, involve changing the free flow cross-section of the ventilation valve 16b.

Consequently, the crankcase 102 can be ventilated by controlling the flow adjustment device 16a, which is designed as a disk separator, and by controlling the flow adjustment device 16b, which is designed as a ventilation valve. Preferably, the control device 24 coordinates the operating states of the flow adjustment devices 16a, 16b with one another.

In the internal combustion engine 100 shown in FIG. 3, the breather system 10 also comprises two flow adjustment devices 16a, 16b. The flow adjustment device 16a is a disk separator.

The flow adjustment device 16b is a ventilation valve. In this case, the ventilation line 12 for introducing the ventilation gas into the crankcase 102 is connected to the high-pressure area 120 of the exhaust line 116. The flow adjustment device 16b, which is designed as a ventilation valve, is arranged on the ventilation line 12. The ventilation line 12 is thus a high-pressure line, which is located upstream of the turbine 118 of the exhaust gas turbocharger 108 in the direction of flow of the exhaust gas A. In this case, the ventilation gas is exhaust gas A. The crankcase 102 is thus ventilated with exhaust gas A from the exhaust line 116 coming from the combustion chambers 104a-104d of the internal combustion engine 100.

The control devices 24 of the illustrated breather systems 10 may be arranged to control the flow adjustment devices 16a, 16b depending on the quantity and/or concentration of the fuel and/or reaction products in the breather system 10 when the quantity and/or concentration of the fuel and/or reaction products exceeds a limit value. Furthermore, the control devices 24 may be arranged to control the flow adjustment devices 16a, 16b independently of the quantity and/or concentration of the fuel and/or reaction products in the breather system 10 if the quantity and/or concentration of the fuel and/or reaction products falls below a limit value. Furthermore, the control devices 24 can also be set up to control the flow adjustment devices 16a, 16b as a function of the pressure in the crankcase 102 and/or a required media separation, for example a required oil mist separation.

### REFERENCE SIGNS

10 Breather system
12 Ventilation line
14 Leakage gas discharge line
16a, 16b Flow adjustment devices
18 Conveyor drive
20 Oil return line
22 Gas return line
24 Control device
26a-26e Measuring devices
100 Internal combustion engine
102 Crankcase
104a-104d Combustion chambers
106 Suction line
108 Exhaust gas turbocharger
110 Compressor
112 Low pressure area
114 High pressure area
116 Exhaust line
118 Turbine
120 High pressure area
122 Low pressure area
A Exhaust gas
B1-B5 Areas
G Gas mixture
F Fresh air

1. A breather system for a crankcase of an internal combustion engine operable with a gaseous fuel, in particular for a crankcase of a hydrogen internal combustion engine, in which leakage gas containing the fuel and/or reaction products of the fuel enters the crankcase during the combustion process, with
a leakage gas discharge line for discharging from the crankcase a gas mixture comprising a ventilation gas and leakage gas introduced into the crankcase; and
one or more flow adjustment devices for adjusting the volume flow of the ventilation gas introduced into the crankcase and/or the volume flow of the gas mixture discharged from the crankcase, wherein one flow adjustment device is designed as a centrifugal separator, in particular as a disk separator, for conveying the discharged gas mixture through the leakage gas discharge line; and
a control device which is set up to control the one or more flow adjustment devices as a function of a quantity and/or concentration of the fuel and/or the reaction products in at least one area of the breather system in order to change the volume flow of the ventilation gas introduced into the crankcase and/or in order to change the volume flow of the gas mixture discharged from the crankcase.

2. The breather system according to claim 1,
wherein the control device is set up to control the conveying performance of the centrifugal separator as a function of a quantity and/or concentration of the fuel and/or the reaction products in the at least one area of the breather system.

3. The breather system according to claim 1,
wherein the centrifugal separator has a conveyor drive which is set up to rotationally drive a conveying rotor of the centrifugal separator,
wherein the control device is set up to control the conveying performance of the centrifugal separator via the setting of a rotational speed on the conveyor drive (18).

4. The breather system according to claim 1,
further comprising a flow adjustment device is designed as a ventilation valve for adjusting the volume flow of the ventilation gas introduced into the crankcase, wherein the control device is preferably set up to adjust the ventilation valve as a function of a quantity and/or concentration of the fuel and/or the reaction products in the at least one area of the breather system.

5. The breather system according to claim 4,
further comprising a ventilation line for introducing the ventilation gas into the crankcase, wherein the ventilation valve is preferably arranged on the ventilation line.

6. The breather system according to claim 1,
further comprising at least one measuring device which is set up to measure the quantity and/or concentration of the fuel and/or the reaction products in the at least one area,
wherein the control device is set up to control the one or more flow adjustment devices as a function of the quantity and/or concentration of the fuel and/or the reaction products measured by the measuring device in the at least one area of the breather system for varying the volume flow of the ventilation gas introduced into the crankcase and/or for varying the volume flow of the gas mixture discharged from the crankcase.

7. Breather The breather system according to claim 1,
further comprising a data processing device which is set up to calculate the quantity and/or concentration of the fuel and/or the reaction products for the at least one area,
wherein the control device is set up to control the one or more flow adjustment devices as a function of the quantity and/or concentration of the fuel and/or the reaction products calculated by the data processing device for the at least one area of the breather system in order to change the volume flow of the ventilation gas introduced into the crankcase and/or in order to change the volume flow of the gas mixture discharged from the crankcase.

8. The breather system according to claim 6, wherein
the at least one measuring device is arranged in the crankcase, in a flow adjustment device, on the leakage gas discharge line, on a suction line leading to combustion chambers of the internal combustion engine or on an exhaust line coming from combustion chambers of the internal combustion engine; and/or
the at least one area, in which the quantity and/or concentration of the fuel and/or the reaction products is measured and/or for which the quantity and/or concentration of the fuel and/or the reaction products is calculated, is located in the crankcase, in a flow adjustment device, in the leakage gas discharge line, in a suction line leading to combustion chambers of the internal combustion engine or in an exhaust line coming from combustion chambers of the internal combustion engine.

9. The breather system according to claim 1,
wherein the control device is set up to control the one or more flow adjustment devices
as a function of the quantity and/or concentration of the fuel and/or reaction products in the at least one area of the breather system, if the quantity and/or concentration of the fuel and/or reaction products in the at least one area of the breather system exceeds a limit value; and/or
independently of the quantity and/or concentration of the fuel and/or the reaction products in the at least one area of the breather system, if the quantity and/or concentration of the fuel and/or the reaction products in the at least one area of the breather system falls below a limit value.

10. The breather system according to claim 1,
wherein the control device is set up to control the one or more flow adjustment devices as a function of the pressure in the crankcase and/or a required media separation.

11. An internal combustion engine, which can be operated with a gaseous fuel, with
a crankcase ; and
a breather system for the crankcase;
wherein the breather system is designed according to claim 1.

12. A method for venting a crankcase of an internal combustion engine operable with a gaseous fuel, in particular a crankcase of a hydrogen internal combustion engine, in which leakage gas containing the fuel and/or reaction products of the fuel enters the crankcase during the combustion process, by means of a breather system, in particular a breather system according to claim 1, comprising the steps:
Discharging a gas mixture comprising a ventilation gas and leakage gas introduced into the crankcase from the crankcase via a leakage gas discharge line of the breather system; and
adjusting the volume flow of the ventilation gas introduced into the crankcase and/or the volume flow of the gas mixture discharged from the crankcase by means of one or more flow adjustment devices of the breather system, wherein a flow adjustment device is designed as a centrifugal separator, in particular as a disk separator, for conveying the discharged gas mixture through the leakage gas discharge line;
wherein a control device of the breather system controls the one or more flow adjustment devices as a function of a quantity and/or concentration of the fuel and/or the reaction products in at least one area of the breather system for changing the volume flow of the venting gas introduced into the crankcase and/or for changing the volume flow of the gas mixture discharged from the crankcase.

13. The method according to claim 12,
wherein
the control device controls the conveying performance of the centrifugal separator as a function of a quantity and/or concentration of the fuel and/or the reaction products in at least one area of the breather system; and/or
a flow adjustment device is designed as a ventilation valve for adjusting the volume flow of the ventilation gas introduced into the crankcase, wherein the control device preferably adjusts the ventilation valve as a function of a quantity and/or concentration of the fuel and/or the reaction products in at least one area of the breather system.

14. The method according to claim 12, further comprising at least one of the following steps:
measuring the quantity and/or concentration of the fuel and/or the reaction products in the at least one area by means of at least one measuring device of the breather system;
calculating the quantity and/or concentration of the fuel and/or the reaction products-for the at least one area by means of a data processing device of the breather system.
